(19) United States
(12) Patent Application Publication
(10) Pub. No.: US 2023/0020631 A1
(43) Pub. Date: Jan. 19, 2023

(54) EAR CANAL DEFORMATION BASED CONTINUOUS USER IDENTIFICATION SYSTEM USING EAR WEARABLES

(71) Applicant: The Florida State University Research Foundation, Inc., Tallahassee, FL (US)

(72) Inventors: Jie Yang, Tallahassee, FL (US); Zi Wang, Tallahassee, FL (US)

(21) Appl. No.: 17/365,285

(22) Filed: Jul. 1, 2021

(51) Int. Cl. G06F 21/32; H04R 3/04; G10L 25/51; H04R 1/10; H04R 1/08; G01P 13/00

(52) U.S. Cl. CPC G06F 21/32; H04R 3/04; G10L 25/51; H04R 1/1016; H04R 1/08; H04R 1/1041; G01P 13/00; H04R 2420/07

(57) ABSTRACT

Disclosed herein is a system and methods for ear canal deformation based user authentication using in-ear wearables. This system provides continuous and passive user authentication and is transparent to users. It leverages ear canal deformation that combines the unique static geometry and dynamic motions of the ear canal when the user is speaking for authentication. It utilizes an acoustic sensing approach to capture the ear canal deformation with the built-in microphone and speaker of the in-ear wearable. Specifically, it first emits well-designed inaudible beep signals and records the reflected signals from the ear canal. It then analyzes the reflected signals and extracts fine-grained acoustic features that correspond to the ear canal deformation for user authentication.

### BACKGROUND

Recently, the new-generation in-ear wearables have integrated various sensors (e.g., microphones, vibration and motion sensors) to provide better user experience and to support a wide range of emerging applications. For example, the Apple AirPods Pro® equips multiple outward-facing and inward-facing microphones to improve the ability of the active noise cancellation [6]. The Huawei Freebuds® embeds bone vibration sensors to enhance the quality of voice recording [1], whereas the Jabra Sport® earbud integrates motion sensors to support fitness monitoring [2]. These embedded sensors in the wearables can not only support various mobile applications but also provide opportunities to sense and capture new types of biometrics. For example, it is possible to utilize the embedded sensors in the in-ear wearable to capture a user's ear canal structure, which is unique to each individual for user authentication. Moreover, many emerging applications that enabled by the in-ear wearable, such as the voice assistant for smart home and IoT devices, require secure user authentication to protect sensitive and private information. Traditional voice-based user authentication is convenient but has been proven vulnerable to the voice spoofing attack [21, 22, 49]. Reusing in-ear wearable to capture the ear canal structure for user authentication thus provides a novel and promising approach to enhance system security.

Comparing to traditional biometrics, the ear canal based authentication has several advantages. First, it relies on the unique geometry of the ear canal, which is hidden within the human skull. It is thus more resilient to the spoofing attack than the traditional biometrics, such as fingerprint, voice, or face. For example, the victim's voice can be recorded by an attacker within the vicinity using a smartphone [22], whereas the facial authentication can be spoofed using the photos or videos of the victim [30, 38]. Moreover, the ear canal based approach can provide continuous authentication, whereas the fingerprint and face biometrics mainly focus on one-time authentication. In addition, the ear canal based authentication is transparent to the users as it doesn't require any user cooperation. Traditional biometrics, however, require explicit user operation, such as pressing the fingertip on the fingerprint reader or posing the face to the camera [8, 28]. The unique advantages of the ear canal based authentication could potentially benefit many emerging applications, such as Virtual Reality (VR) and Audio Augmented Reality (AAR). For example, AAR utilizes earbuds to provide the user with acoustic information that corresponds with the physical reality and is widely used in museum or event tour. Wearing earbuds is a prerequisite for a better immersive experience but not an additional burden for the user. In VR, due to the view of the user is completely blocked from the environment, simply utilizing traditional authentication methods are very challenging. For example, existing authentication methods become less secure and more vulnerable to various attacks under the VR setup. Similarly, using hand gestures to input PIN in a virtual keyboard is vulnerable to video-recording attack while voices sample could be easily recorded at a close distance for the mimic attack without user knowledge. Ear canal based authentication is thus both convenient and more secure for those applications.

What is needed in the art is a system for measuring ear canal deformation due to articulation activities. This system, which is disclosed herein, includes more dynamic information and can provide better and more secure user authentication while the user is speaking.

### SUMMARY

Disclosed herein is a system for acoustic authentication of a user, the system comprising: a microphone configured to face into the ear canal of a user, wherein said microphone comprises a transmitter for transmitting a probe signal, and a receiver for receiving and recording signal reflections from the ear canal of the user, wherein said signal reflections are based on ear canal dynamic deformation and ear canal geometry information; an authenticator, configured to determine a current user acoustic signature from the receiver and to compare the current user acoustic signature with a predefined user acoustic signature and to authenticate the user based on the comparison of the current user acoustic signature with the predefined user acoustic signature; and housing, wherein said microphone and authenticator are housed inside said housing. Also disclosed is a method which uses the system disclosed herein.

### BRIEF DESCRIPTION OF FIGURES

FIG. 1 shows the auditory system of the human ear.

FIG. 2 shows temporomandibular joints of the human skull.

FIG. 3 shows the sternocleidomastoid muscle.

FIG. 4 shows articulatory Phonetics: Jaw and tongue position.

FIG. 5 shows vowels categories based on the jaw and tongue position.

FIG. 6 shows consonants categories based on the jaw and tongue position.

FIG. 7A-H shows the core idea of the EarDynamic.

FIG. 8 shows system flow of EarDynamic.

FIG. 9 shows decision tree of choosing deformation template.

FIG. 10 shows channel response of the same ear canal deformation category for same participant.

FIG. 11 shows channel response of different ear canal deformation categories for same participant.

FIG. 12 shows channel response of the same ear canal deformation category for different participants.

FIG. 13 shows the prototype built with off-the-shelf devices.

FIG. 14 shows ROC curves under without and with boosting.

FIG. 15 shows classifier boosting with multiple phoneme.

FIG. 16 shows performance comparison of using static template and deformation-based template for user authentication.

FIG. 17 shows correlation comparison between deformation-based template and only using static template.

FIG. 18 shows correlation of ear canal features comparison between valid user and model mimic attack.

FIG. 19 shows authentication performance in different environments with different background noise.

FIG. 20 shows authentication performance with different head posture.

FIG. 21 shows authentication performance with different wearing angles.

FIG. 22 shows authentication performance over different time of period.

FIG. 23 shows authentication performance with different body motions.

FIG. 24 shows authentication performance based on left ear or right ear.

FIG. 25 shows user study on gender.

FIG. 26 shows user study on accent

FIG. 27 shows User study on age.

### DETAILED DESCRIPTION

The system disclosed herein, referred to as Eardynamic, is a continuous user authentication system that leverages the ear canal deformation sensed by the in-canal deformation reflects the ear canal dynamic motion caused by jaw joint or articulation activities, for example, when the user is speaking. Thus, the ear canal deformation not only contains the static geometry of ear canal that represents the physiological characteristic of the user but also includes the geometry changes that characterizes the behavioral properties of the user while speaking. Recent prior work shows that the static geometry of the ear canal is unique for every individual [15]. It is disclosed herein that the ear canal deformation due to articulation activities includes more dynamic information and can provide better and more secure user authentication while the user is speaking.

In particular, the system disclosed herein utilizes an acoustic sensing approach to capture the ear canal deformation with the embedded microphone and speaker of the in-ear wearable. It first emits inaudible beep signals from the in-ear wearable to probe the user's ear canal. It then records back the reflected inaudible signals together with the user's audible sounds. The reflected inaudible signals thus contain the information of the ear canal dynamic motions, i.e., the changes of the geometry of ear canal, due to the movements of the jaw joint and other articulators. More specifically, human speech relies on the motions of multiple articulators (e.g., jaw, tongue, mouth) to pronounce various phonemes. When the jaw moves, the temporomandibular joint (TMJ) also moves which causes either expansion or compression of the ear canal wall. Such a phenomenon caused by TMJ movements is known as the Ear Canal Dynamic Motion (ECDM) [12]. Such motions results in various effects over different people [32]. For example, during the speaking process, each person's ear canal will either be expanded or compressed at various degrees and speeds. It was found that the ear canal deformation is consistent for the same individual while varies depending on the individual anatomy and behavior. Thus, by utilizing the ear canal deformation extracted from the reflected acoustic signals, our system can distinguish different users.

To better leverage the ear canal deformation and improve the usability of our system, various dynamic motions were categorized into different groups based on the phoneme pronunciations. In particular, although canal dynamic motions cannot be directly measured, one can infer such motions based on the articulatory movements. However, measuring the articulatory movements requires specialized sensors attached to the articulators, which are impractical. This challenge was solved by looking at the phonemes in the user's speech. Specifically, each phoneme pronunciation corresponds to unique and consistent articulatory movements. The canal dynamic motions thus can be identified by recognizing each phoneme and the corresponding articulatory movements. Consequently, the ear canal dynamic motions for the phonemes that are invoked by similar jaw and tongue movements share high similarity and can be categorized into the same group. Such a categorization can also reduce the calculation complexity and shorten the authentication time.

To perform user authentication, the system disclosed herein extracts fine-grained acoustic features that correspond to the ear canal deformation and compares these features against the user enrolled profile. To evaluate EarDynamic, experiments were conducted with 24 participants in various noisy environments (i.e., home, office, grocery store, vehicle, and parks). The system was also evaluated under different daily activities during the user authentication process (i.e., maintain different postures, perform different gestures). The results show EarDynamic achieves high accuracy and maintains comparable performance in different noisy environments and under various daily activities. The contributions of this work are summarized as follows:
1. It is shown that the dynamic deformation information of the ear canal is unique for each individual and can be utilized for user authentication. Ear canal dynamic motions are further categorized into various groups based on the phoneme pronunciation to facilitate user authentication.
2. EarDynamic was proposed, a continuous and user transparent authentication system utilizing in-ear wearable devices. It leverages ear canal deformation that combines the unique static geometry and dynamic motion of the ear canal when the user is speaking for authentication. A prototype of EarDynamic was built with off-the-shelf accessories by embedding an in-ward facing microphone inside an earbud.
3. Extensive experiments were conducted to evaluate the performance of the proposed EarDynamic. Experimental results show that our system achieves a recall of 97.38% and an F1 score of 96.84%. Results also show that EarDynamic works well under different noisy environments with various daily activates.

System and Attack Model

The system disclosed herein utilizes dynamic deformation of the ear canal captured by the in-ear wearable for user authentication. It requires the in-ear wearable equipped with one microphone and one speaker. The authentication can be continuous, which means the microphone keeps sending inaudible probe signals for continuous authentication. Or the authentication can be triggered on-demand based on the requirements of the mobile applications.

The authentication process is also transparent to the users as it doesn't require any user cooperation. During authentication, the user is free to speak, conduct activities, or remain silent. If the user is speaking or conducting activities, the dynamic ear canal deformation is extracted for authentication. In this work, two types of attack models are considered mimic attacks and advanced attacks. For the mimic attacks, an adversary attempts to compromise the system by spoofing the ear canal deformation of the legit user. In particular, an adversary wears the victim's in-ear device and tries to issue the voice commands for user authentication. Moreover, the attacker might mimic the jaw or head motions of the legitimate user to bypass the user authentication.

The second type of attack is an advanced attack. Although the ear canal is hidden within the human skull, it is still possible such information could be leaked, for example, through the 3D ear canal scanning when the victim needs to produce a hearing-aid or cure ear disease. For this type of attack, it is assumed an adversary acquires the user's ear canal geometry information and could rebuild it precisely, such as using 3D-printing technology. Such attacks may easily bypass the system that only utilizes the static geometry of the ear canal for user authentication. However, it is extremely hard, if not possible, for an adversary to reproduce the dynamic motions of the ear canal to bypass the ear canal deformation based authentication.

Geometry of Ear Canal

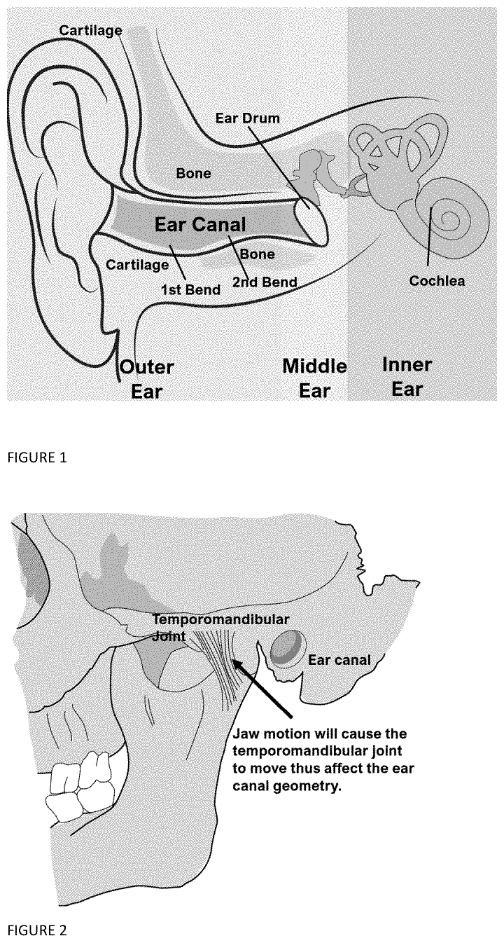

The ear is the auditory system of humans, which consists of three parts, outer ear, middle ear, and inner ear, as shown in FIG. 1. The ear canal, together with pinna, makes up the main components of the outer ear. The ear canal has a tube-like structure and ends at the outer surface of the eardrum. Its primary function is transmitting and coupling sounds. There exists a wide variety of geometry of the human ear canal across the population due to its geometric complexity. These varieties can be attributed by three aspects: interspace of the ear canal, the curvature and cross-section of the canal, and the composition of the ear canal wall.

Firstly, the interspace of the ear canal varies from one individual to another [34, 34, 36]. As shown in FIG. 1, the ear canal of the adults is an “S” shape like a tube. It usually has two bends with different angles that divide the whole canal into three sections. For different individuals, the variations lie in different aspects such as length, size, and shape of the ear canal. For the length, a prior study [34] suggests that the length of the ear canal can vary from 14.20 mm to 29.36 mm, while the standard deviation of the ear canal length is approximately 2 mm among males and is 5% longer for females on average. Moreover, the volume of the ear canal's interspace ranges approximately from 1000 to 1400 mm3 [36], and other recent studies involve more subjects reports that the smallest interspace could be as low as 372 mm3 with a mean volume of 843 mm3 [34].

Moreover, both the curvature and cross-section of the canal are also unique for different people. The curvature is usually measured along the center axis of the ear canal. The ear canal of certain individuals could be straight but are bent for others. In one study involving 185 adults suggests that for about 30% of the subject being studied, the entire eardrum could be seen from the point of view near the pinna. On the other hand, about 9% of testing subjects' eardrum is invisible from the viewpoint at the same position, which indicates these ear canals are relatively narrow and curved [25]. Furthermore, the cross-sectional area changes over the entire course of the ear canal due to its complex structure. For example, in the middle portion of the canals, the cross-sectional areas can range between 25 and 70 mm2 for different subjects [43].

Lastly, the composition of the ear canal wall is skin, cartilaginous, and bone where the proportion of cartilaginous and bone are different for each person. As shown in FIG. 1, part of the ear canal wall is mainly the cartilaginous and the remaining parts are the bones. The ear canal wall consists of two portions that separated with an osteocartilaginous junction. The first one is the outer cartilaginous portion, where the ear canal wall is constituted with skin and cartilaginous. This portion usually comprises ⅓ to ½ of the total length of the ear canal and varies from one individual to another. The other portion is the inner osseous portion, where the ear canal wall mainly consists of skin and bone. It is worth noticing that the tympanic membrane, the junction of the outer ear and the middle ear, may also be considered as part of the ear canal wall. The yielding ear canal wall is more likely to absorb energy than those consists of skin and bone. Compare to the floor of the canal, the eardrum terminates the ear canal in a range of angles from 45° to 60° [36].

Dynamic Deformation of Ear Canal

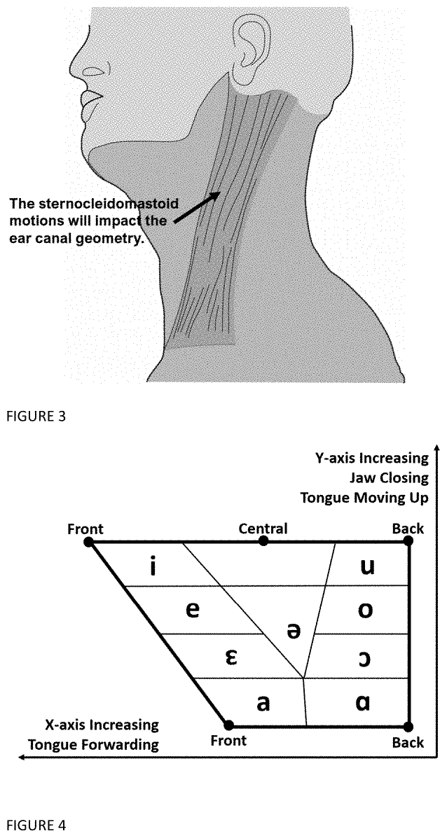

Because human speech relies on the motions of articulators including jaw, tongue, and lips, it also causes the dynamic deformation (i.e., expansion or compression) of the ear canal, known as the Ear Canal Dynamic Motion (ECDM). Such motions mainly consist of mouth motion and head motions. Specifically, mouth motion includes both jaw and tongue movement, where the geometry of the ear canal changes when people are speaking or chewing. As shown in FIG. 2, this is due to the temporomandibular joints (TMJ), the two joints connect the jaw with the skull are located near the ear canal walls. When people are speaking or chewing, the jaw movement drives the temporomandibular joints to move, thus further shifting the ear canal wall and changing the geometry of the ear canal. Furthermore, the head motions will also impact the shape of the ear canal. The sternocleidomastoid muscle, as shown in FIG. 3, is one of the largest and strongest neck muscles attached to the skull near the ear canal. When the head is turning from side to side, the sternocleidomastoid muscle will compress or expand the ear canal.

One important observation is that the dynamic deformation of the ear canal also has diversity. Research [32] shows that with the same motion of open mouth (e.g., drop the jaw), the volume changes vary from person to person. The ear canal volume will be compressed as high as 10 mm3 for about 25% of the testing subjects and expanded as high as 25 mm³ for 67% of the subjects. Meanwhile, the volume of the remaining 8% of the subjects' ear canal keeps the same even when the joints move. The ear canal diameters also change differently for different individuals. An experiment involving 1488 ears suggests that with a similar joints motion, about 20% of the subject's ear canal diameters decrease while the remaining subjects increase up to 2.5 mm³. Some studies [17] also show that the ear canal moves anteriorly, posteriorly, or with a combination of both for different people. In this work, it was confirmed that the dynamics of the ear canal have individual differences. Thus, the ear canal deformation caused by articulation activities could be leveraged for user authentication.

Ear Canal Deformation Categorization

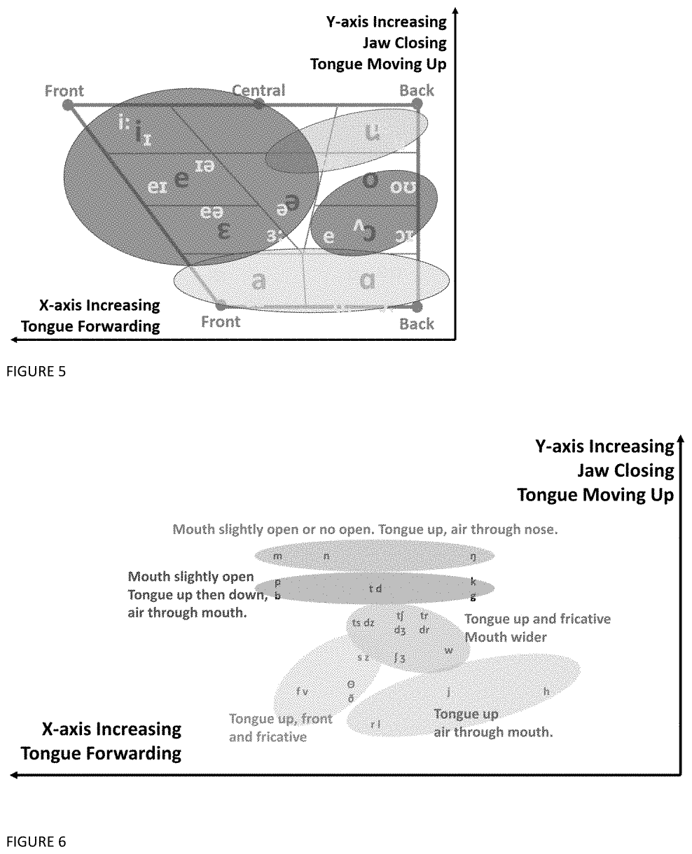

To better leverage the ear canal deformation and improve the usability of our system, various ear canal dynamic motions were categorized into different groups. As the ear canal deformation is invoked by the movements of the articulators (e.g., jaw, tongue, and mouth) when the user is speaking, we thus can categorize deformation by measuring various articulator gestures. But such measurements usually require multiple specialized devices attached to the articulators, which are impractical and cumbersome. To solve this technique challenge, phoneme pronunciation is relied upon. In particular, each phoneme pronunciation corresponds to unique and consistent articulatory gestures. By grouping the phonemes with similar articulatory gestures, the corresponding ear canal deformation can be grouped. Thus, the phonemes are categorized with a similar scale of jaw and tongue movements into the same groups. Then, the corresponding ear canal deformations belong to the same group as well due to the deformation are caused by similar jaw and tongue movements. Such grouping is then refined by experimenting on different subjects and re-categorize the phonemes/deformations with high similarity. Specifically, phonemes are the smallest distinctive unit sound of a language and can be divided into two major categories: vowels and consonants. Based on the position of the jaw and tongue when pronouncing them, phonemes can be categorized into different groups. FIG. 4 illustrates the articulatory phonetics correspond to the various position of tongue and jaw. The y-axis shows the height information of the speaker's tongue. It indicates the vertical placement of the tongue at various degrees, which also associated with the jaw openness. The x-axis represents the depth information, which implies the forward or backward level of the tongue within the mouth. And the vowels are categorized based on the Articulatory Phonetics, as shown in FIG. 5. For instance, the phoneme [i] on the left-up corner of the chart is a vowel, where the jaw is closed and the tongue is at a high and forward position closed to the palate and tooth during pronunciation. On the other hand, the phoneme [a] on the left lower corner is another vowel, where the jaw is open and the tongue is at a low and back position when pronouncing it. Similarly, one can categorize the consonants based on the position of the jaw and the tongue, as shown in FIG. 6. Specifically, the x-axis shows the vertical placement of the tongue and the y-axis represents the depth information.

Ear Canal Deformation Sensing

Measuring the geometry of the ear canal directly is challenging due to its structural complexity. Specifically, instead of being a straight tube, the ear canal is an “S” shaped cavity and its cross-section keeps changing along the entire canal. Moreover, due to the complex articulatory gestures, the dynamic deformation caused by these gestures is also difficult to capture directly. For example, the jaw motion can result in various deformation on the ear canal in different directions. The measuring process becomes even more difficult when combining the static geometry with the dynamic deformation of the ear canal.

In this work, an acoustic sensing approach is used to capture the ear canal deformation indirectly. It is done by emitting inaudible acoustic signals to probe the ear canal and analyzing the signal reflections that affected by various geometric characteristics of the ear canal (e.g., the interspace, the curvature, the diameter of the ear canal, and the canal wall composition). A prototype is built using off-the-shelf ear-bud equipped with an inward-facing microphone that enables both transmitting probe signals and recording the signal reflections from the ear canal. Moreover, we leverage the channel response to measure the ear canal dynamic deformation and its geometry information. Specifically, the channel response of the ear canal is the ratio of the reflected signal to the incident probe signals. The channel response depicts how the ear canal deformation (i.e., wireless channel) reflects the original probe signals. By analyzing the channel response, different users can be distinguished based on their unique ear canal deformation.

System Overview

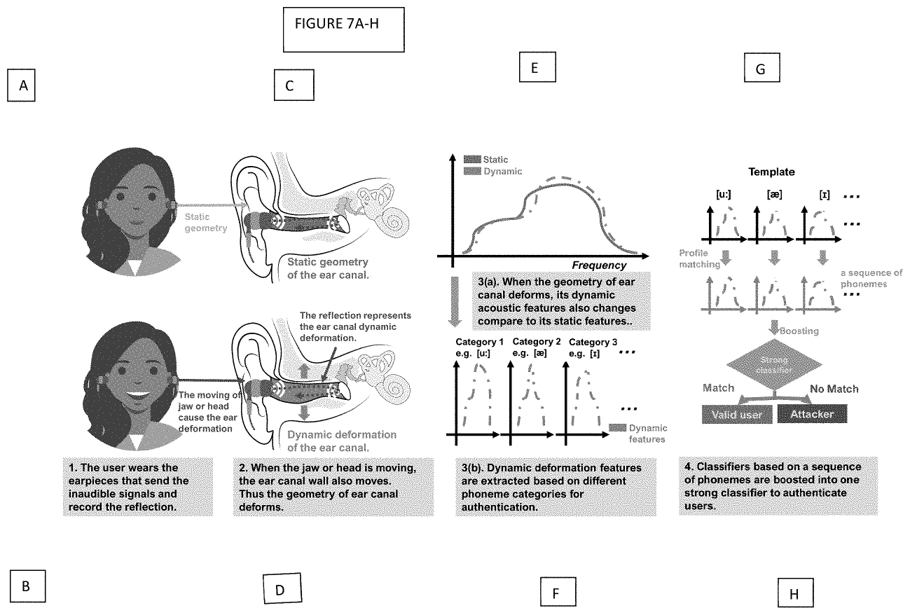

The key idea underlying the user authentication system is to leverage the advanced acoustic sensing capabilities of the in-ear wearable device to sense the dynamic deformation of the user's ear canal. As illustrated in FIG. 7, when the user is wearing EarDynamic, the earbud emits an inaudible chirp signal to probe the ear canal. Then the signal reflected from the ear canal is captured by the inward-facing microphone that can be further utilized to extract the dynamic deformation of the ear canal.

This system has the ability to work under both static and dynamic scenarios of the ear canal. When there is no head movements or articulatory motions detected, the user is under a static scenario, where the ear canal geometry remains the same throughout the authentication process. Thus, the captured signal reflections represent the physiological characteristics of the user's ear canal. Then the extracted features that correspond to static geometry of the ear canal are utilized to compare against the user enrolled profiles to determine if it is the legit user.

Different from the static scenario, dynamic deformation represents the combination of both the physiological and behavioral characteristics of the ear canal. It can be extracted under the dynamic scenarios, where the user is speaking or moving the head. To better leverage the ear canal deformation, various deformation motions are categorized into different groups based on phoneme pronunciation, such that each group shares similar jaw and tongue movements. Such an approach has the benefit of improving system usability by simplifying the profile enrollment process. For example, the disclosed system only requires the user to speak a few sentences that involve multidimensional motions of the jaw and tongue to generate an individual profile for later authentication. To identify the head movement, the present system relies on the embedded motion sensor of the wearable. In particular, five head postures are considered that lead to ear canal deformation including turning right, left, down, up, and forward.

The disclosed system can perform authentication when users wearing in-ear devices with their natural habits. By utilizing embedded inward-facing microphone and motion sensor, which have been increasingly adopted on the wearable devices, EarDynamic is highly practical and compatible. Compare with the traditional biometric authentication modalities, such as fingerprint and face, our system can achieve continuous authentication and is transparent to the user without requiring any user cooperation.

System Flow

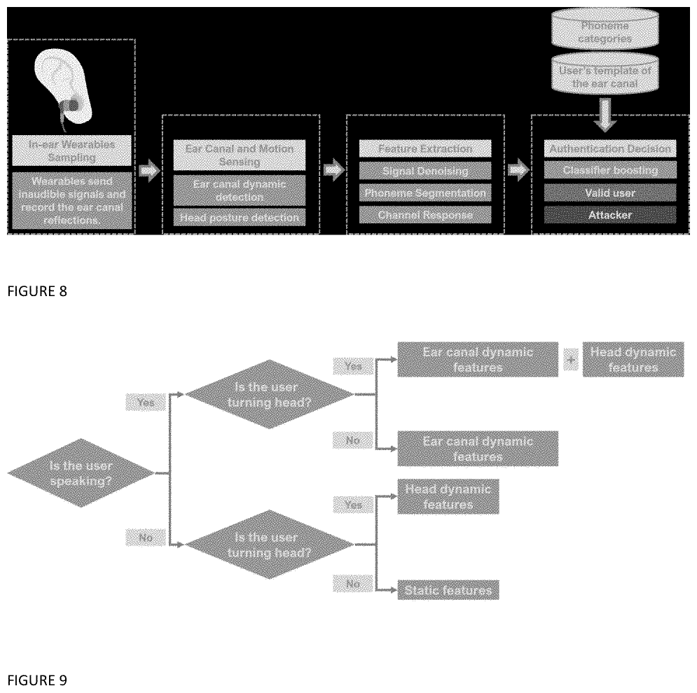

The disclosed system consists of four major components: in-ear wearable sampling, ear canal, and motion sensing, dynamic feature extraction, and user authentication, shown in FIG. 8. The authentication process can be triggered on-demand or continuously depending on the applications. Once triggered, the system first sends the probe signals and records the signal reflections. Meanwhile, the audible signal that contains phoneme information of the user's speech is also be recorded. Furthermore, the motion sensor captures the head movements. Then, the system moves on to the feature extraction component.

For feature extraction, the captured signals that consist of the reflected inaudible signals and the audible signals are processed. A high pass filter was first applied to separate the inaudible and audible signals. The inaudible signals contain the acoustic properties of the ear canal, whereas the audible signals include the speech content of the user. Next, the system segments the separated audible signals into a sequence of phonemes and maps them to the corresponding inaudible components for capturing the ear canal deformation. The phoneme segmentation is done by utilizing the Munich Automatic Segmentation system [39] on both the audible signal components and inaudible signal components. For each segment, appropriate features are extracted based on different scenarios, as shown in FIG. 9. In particular, if the user is speaking while moving his/her head, both the ear canal dynamic and head dynamic feature are extracted, respectively. On the other hand, if there is no head motion or mouth movement, the static geometry of the ear canal is extracted.

Lastly, the system can authenticate the user based on the extracted information from previous steps. A sequence of phoneme-based classifiers that can be combined as one stronger classifier to improve classification accuracy. If a positive decision is given, then the user is considered as legit. Otherwise, the system deems the current user as an unauthorized user.

Ear Canal Sensing

Once the system is triggered, the speaker of the in-ear wearable sends out acoustic signals to probe the ear canal. The probe signals are designed as a chirp signal with frequency ranges from 16 kHz to 23 kHz. The reason for such a design is twofold: first, the frequency range from 16 kHz to 23 kHz is inaudible to most human ears, which makes the authentication process transparent to the user; second, the chosen frequency range is sensitive to the subtle motions, which can improve our system's ability to capture the ear canal deformation. During the process of ear canal sensing, the inward-facing microphone keeps recording the reflected signals bounced from the ear canal. These reflections can be analyzed to further extract the acoustic properties of the ear canal.

Signal Processing

Ear Canal Deformation Categorization. The underlying principle of ear canal deformation categorization is that similar articulatory gestures, i.e., jaw and tongue motions, have a similar impact on the geometry of the ear canal. In particular, each phoneme is produced by a sequence of coordinated movements of several articulators. In this work, the focus is on two articulators (i.e., jaw and tongue) that contribute the most to the ear canal deformation. For example, the phoneme sound of [ [symbol] :] and [a] both have a lower and backward position with an open jaw. Thus, these two phonemes result in a similar impact on the ear canal deformation and are categorized into the same group. Several phonemes were eliminated due to the fact that they have minimal usage of articulators, which leads to almost no impact on the ear canal deformation. For instance, when the user pronounced the phoneme [p], no ear canal deformation was detected. The categorization results of commonly used vowels and consonants are summarized in Table 1.

TABLE 1
Deformation Categories Based on Phoneme

| Deformation (Articulator) Category | Phonemes |
|---|---|
| Tongue Forward and Jaw Open Slightly | [i [symbol] ], [ [symbol] ], [ [symbol] ], [ [symbol] ], [ [symbol] ], |
| | [ [symbol] ], [ [symbol] ] |
| Tongue Lower and Jaw Open Widely | [ [symbol] ], [ai], [ [symbol] ], [ [symbol] ], [ [symbol] ], |
| | [ [symbol] ] |
| Tongue Back and Raise and Jaw Open Slightly | [ [symbol] ], [ [symbol] ], [ [symbol] ] |
| Tongue Back and Jaw Open Moderately | [ [symbol] ], [ [symbol] ], [ [symbol] ], [ [symbol] ] |
| Tongue Raised and Fricative and Jaw Open | [t [symbol] ], [tr], [ts], [d [symbol] ], |
| Widely | [dr], [dz] |
| Tongue Raised and Jaw Open Slightly | [f], [s], [ [symbol] ], [h], [ [symbol] ], [z], |
| | [ [symbol] ], [r] |
| Tongue Fricative and Jaw Open Slightly | [θ], [ [symbol] ], [ [symbol] ] |

[symbol]

indicates data missing or illegible when filed

As each phoneme contains unique formats (e.g., frequencies), one can segment and identify each phoneme by analyzing the spectrogram of the audible signal. In particular, the automatic speech recognition protocol is leveraged to identify each word in the sample speech [35]. Then, MAUS is utilized as the primary way of phoneme segmentation and labeling [24]. It is done by transferring the samples into expected pronunciation and searching for the highest probability in a Hidden Markov Model [23]. The segmented and labeled phonemes are categorized according to Table 1 for further analysis.

Feature Extraction. The next step is to extract features from the categorized signals segments. The captured signal reflection from the ear canal contains the acoustic characteristics information of the user's ear canal. However, due to the dynamic nature of the ear canal geometry during the speaking process, the channel response of the received signals are also time-varying. Let c₁(t) and c₂(t) denote the channel response of the sample signal i(t₁) and i(t) and i (t−t₁), due to the deformation of the ear canal, the c₂(t) is not equal to the c₁(t). Therefore, the received signals r(t) can be represented as: r(t)=c(t,τ)*s(t)=∫∞−∞s(t−τ)c(t, τ)dτ, where the c(t, τ) is the channel response, and τ is the propagation delay. Thus for each segment of a phoneme of the user, r(tₛ), The channel response c(t) is a function that relates the output response at frequency ω. Thus the channel response is:

$$\text{?}$$

$$\text{?} \text{indicates text missing or illegible when filed}$$

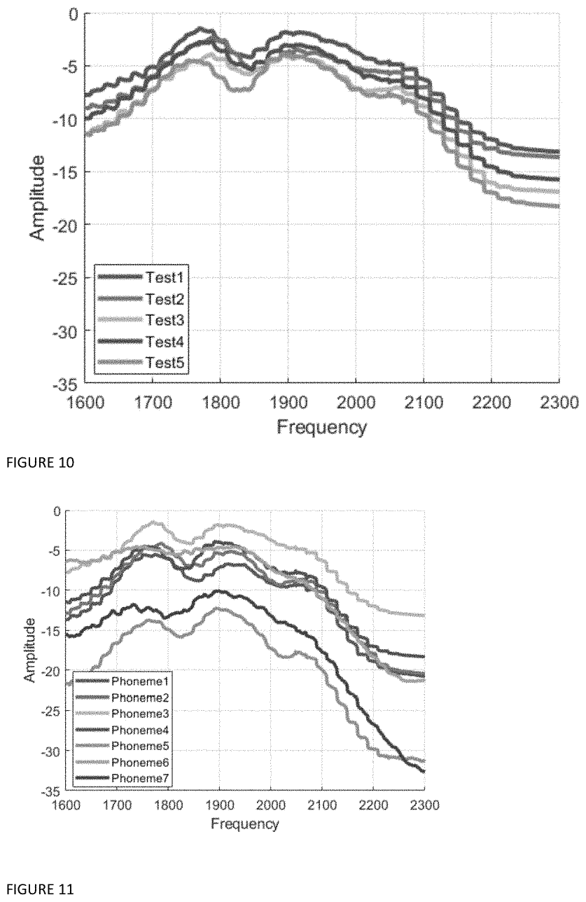

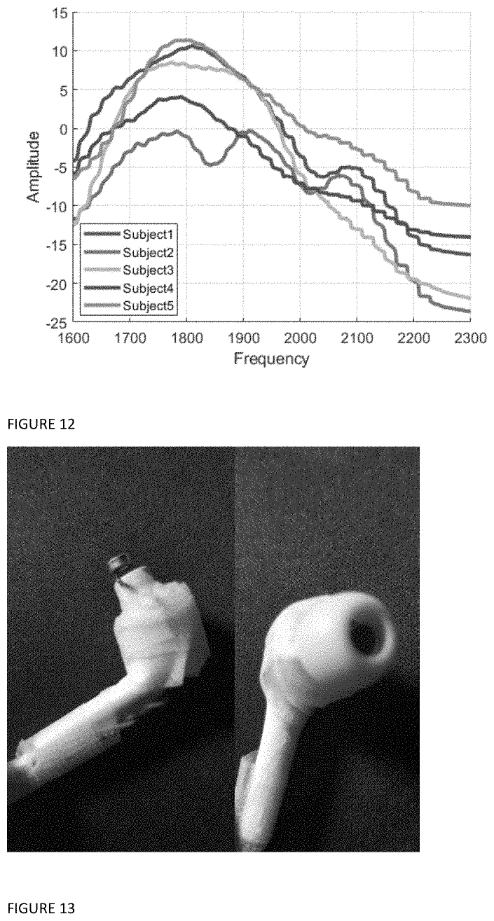

By capturing the channel response under different segments of phonemes, we could extract the acoustics characteristics that represent both the static geometry and dynamic motions of the ear canal at a specific time point. As shown in FIG. 10, the channel responses of different phonemes within the same category collected from the same participant share a high similarity. Furthermore, the channel responses of the phonemes across different categories have lower similarity even when they are collected from the same individual, as illustrated in FIG. 11. Lastly, it was observed that the channel responses of the phonemes from the same phoneme category collected from different users are unique, as depicted in FIG. 12.

Classifier Boosting

After obtaining the feature extracted from received reflected signals, the system proceeds to the authentication process. Such a process can be viewed as finding an optimal solution for a classification problem to distinguish between legit users and attackers. To achieve better performance, adaptive boosting is adopted, which is an ensemble learning algorithm [37]. Such an algorithm is commonly used for classification or regression to further improve the distinguishing ability. Specifically, the authentication problem can be formulated as one boosted classifier:

$${P}_{C} ( x ) = \text{?} ( x )$$

$$\text{?} \text{indicates text missing or illegible when filed}$$

where each segmented phoneme will be used as a weak learner pc that takes one channel response c as input and returns a value indicating the class of the object. Each weak learner pc is one classifier that is only slightly correlated to the final classifier that has one output o(xᵢ) for the input from the training set. By iteratively combining all the weak learners, one can obtain the boost learner which is highly correlated to the final learner, and during each iteration of training i, each weak classifier is selected and assign a coefficient cₜ to minimize the training error:

$$\text{?} = \text{?} E \text{?}$$

$$\text{?} \text{indicates text missing or illegible when filed}$$

where f_{c}(x)=cₜo(x) is the classifier that is boosted into the final classifier, while F_{c-1}(x) is the boosted classifier from the previous iteration. A vector also contains all weights that update information for each sample. It is created to focus on the samples that have relatively bigger errors in the previous stage.

In the context of this application, the term “headset” refers to all types of headsets, headphones, and other head worn audio playback devices, such as for example circum-aural and supra-aural headphones, ear buds, in ear headphones, and other types of earphones. The headset may be of mono, stereo, or multichannel setup. A dedicated microphone for recording the user's voice may or may not be provided as part of a headset in the context of this explanation. The headset in some embodiments may comprise an audio processor. The audio processor may be of any suitable type to provide output audio from an input audio signal. For example, the audio processor may be a digital sound processor (DSP).

The term “ear” in the preceding definition is understood as to refer to any part of the ear of the user, and in particular the outer ear comprising concha, tragus, helix, antihelix, scapha, navicular fossa, pinna, etc. In one embodiment, the influence stems primarily from the pinna of the user.

In one or more embodiments, authenticating the user may include comparing a current signature to a stored or predefined signature. Further, based on the filter transfer function currently generated, a current signature may be generated. The current signature may be generated by applying a transformation and/or function to the current transfer function generated. After computing the current signature, the current signature may be compared with the stored signature. In one or more embodiments, the current signature may be compared with the stored signature by computing the sum of a mean square error (E) between the current signature and the stored signature. The computed sum of the mean square error, or E, may indicate the confidence of a match between the stored signature and the current signature. Moreover, E may be compared to a predetermined threshold. In one or more embodiments, if E is less than the predetermined threshold, then the current signature is considered to match the stored signature. However, if E is greater than the predetermined threshold, then the current signature is not a match to the stored signature. Accordingly, if E is less than the predetermined threshold, then the user is authenticated, and provided access to the contents of the headset's memory and/or a host device that is paired with the headset.

The authentication procedure may in some embodiments be provided during an initial power up process of the headset and once succeeded be valid for a given time interval or until the user powers off the headset.

Alternatively or additionally and in further embodiments, the authentication procedure may be conducted on a continuous or quasi-continuous basis, e.g., in the latter case in regular or irregular timeout intervals. In these embodiments, the authentication procedure simultaneously serves as a so-called “don/doff detection”, i.e., a detection of whether the headset is currently worn, as the authentication would be revoked once the user's ear biometrics would not be determinable anymore from the signals/signature. In some embodiments, at least one further current user acoustic signature is determined and the authentication of the user is revoked based on a comparison of the further current user acoustic signature with the predefined user acoustic signature. For example, in case a further current user acoustic signature is determined from a corresponding further filter transfer function every 5 seconds, it is determinable whether the user still wears the headset. Certainly, the interval may be adapted based on the application and the required security level.

### Example

Experimental Setup:

Environments and Hardware. The authentication process could be happening in various environment under everyday use scenarios. For example, the user might command the voice assistant through the headset in the office environment. Additionally, the user could make payments at groceries using electronic payment or send a message through voice command in the vehicles. Thus, to evaluate our system's performance in real-world environments, various locations including home, office, grocery store, vehicle, and parks were chosen to conduct experiments. Moreover, to better simulate the everyday usage of EarDynamic, participants were asked to wear the system in their natural habits as to how they would wear in-ear devices on a daily basis. The participants were allowed to maintain various posture (sitting, standing, walking) or perform different gestures (e.g., waving arm and hands, moving head) during the experiments.

There are several in-ear earbuds that equipped with inward-facing microphones on the market (e.g., Apple Airpods Pro® [6], Amazon EchoBuds® [4]). However, those devices are less desirable due to firmware restriction and we can not access the raw data for feature extraction. In this work, a prototype system was built utilizing only off-the-shelf hardware to demonstrate its practicability and compatibility. A regular in-ear earbud on the market cost less than 7 dollars with a 12 mm speaker, 3.5 mm audio jack, and a microphone chip with a sensitivity of −28±3 dB. The total cost of this prototype is very low which is more affordable to a wider range of customers compared to the abovementioned earbuds. As shown in FIG. 13, the microphone is attached to the earbud where located in front of the speaker, and kept in the center of the cross-section area. Such design can mitigate the impact of wearing the earbuds in different angles while gives enough surrounding space for the probe signals to propagate through. Two different smartphones were used, including Samsung Galaxy Note 5 and Galaxy S8+ that connect to the prototype to control probe signal emitting and reflected signal recording. To detect the head posture, existing wearable devices use motion sensors such as accelerometer or gyroscope. For this system, MPU6050 is employed, a six-axis motion sensor to detect the user's head position. The motion sensor is attached to the earbud and connected to a Raspberry Pi for data transmission and power.

Data Collection. 24 participants were recruited for the experiments including 12 females and 12 males with an age range from 20 to 40. The participants are informed about the goal of the experiments and asked to talk in their natural way of speaking. For the enrollment, each participant is asked to sit in a classroom environment and wear the prototype at his/her habitual position. Then, they are required to repeat five passphrases three times while the system emitting inaudible signals. Such passphrases are designed to include different dynamic deformation motions from all the categories. Then, the features are extracted from the captured signal reflections along with the audible signals. The extracted features are used to establish each user's template. After enrollment, each participant is asked to speak 10 sentences with length varies from 2 to 20 words. The sentences include some commonly used voice commands like “Hey Google”, “Alexa, play some music” as well as other short daily conversation pieces. For each sentence, each participant is asked to repeat at least 10 times for our experiment. In total 2880 sentences from different users are collected and used for overall evaluation. Among all those sentences, 1080, 700, 300, 300, 300, and 200 sentences are collected at home, in the classroom, in office, in the vehicle, at the grocery store, and park respectively.

Metrics. To better evaluate the authentication performance of the system, four different metrics were introduced: accuracy, recall, precision, and F1 score. They are defined as following:

$$accuracy = \frac{TP + TN}{TP + TN + FP + FN} \qquad ( 4 )$$

$$recall = \frac{TP}{P} = \frac{TP}{TP + FN} \qquad ( 5 )$$

$$precision = \frac{TP}{TP + FP} \qquad ( 6 )$$

$$F 1 score = 2 \times \frac{precision \times recall}{precision + recall} \qquad ( 7 )$$

where TP is the True Positive, TN is the True Negative, FP is the False Positive and FN is the False Negative, respectively. The receiver operating characteristic (ROC) is also leveraged, which represents the relationship between the True Accept Rate (i.e., the probability of identified valid user) and the False Accept Rate(i.e., the probability of incorrectly accept the attacker) when the threshold is varying.

Performance

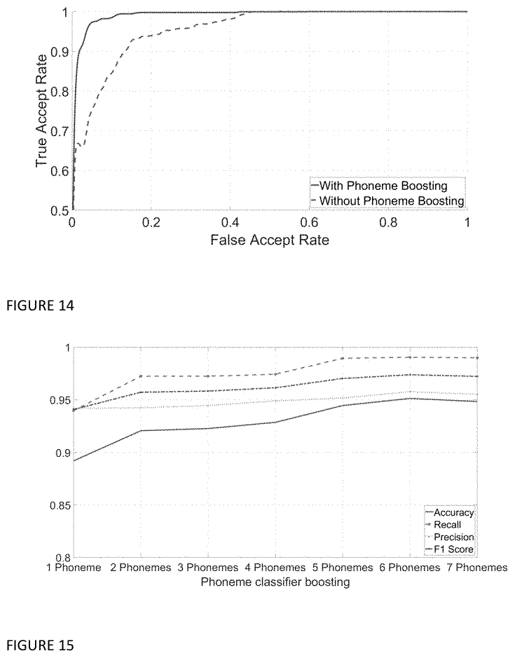

The system's overall performance is evaluated against the mimic attack. To launch a mimic attack, the adversary wears the in-ear device and issue the same voice command by mimicking the victim's way of speaking. For such an attack, the adversary tries to spoof the system by performing similar articulator gestures with respect to the victim. Table 2 summarizes the average and median of accuracy, recall, precision, and F1 score overall. It was observed that EarDynamic can achieve overall accuracy of 93.04%, recall of 97.38%, the precision of 95.02%, and an F1 score of 96.84% across different environments and participants. Furthermore, the median accuracy, recall, precision, and F1 score are 93.97%, 98.78%, 95.40%, and 96.85%, respectively. FIG. 14 shows the ROC curves of our system with and without phoneme boosting. By utilizing the phoneme boosting technique, the system could provide over 95% True Accept Rate with around 5% False Accept Rate. The above results show that EarDynamic is highly effective in distinguishing legit users and attackers under mimic attack, especially after applying phoneme classifier boosting techniques.

TABLE 2
Authentication accuracy

| | Mean | Median | Standard Deviation |
|---|---|---|---|
| Accuracy | 0.9304 | 0.9397 | 0.0395 |
| Recall | 0.9738 | 0.9878 | 0.0381 |
| Precision | 0.9502 | 0.9540 | 0.0202 |
| P1 Score | 0.9684 | 0.9685 | 0.0055 |

When applying classifier boosting techniques, our system requires to utilize multiple phonemes to boost classification accuracy. Next, the system's performance is studied by using the various number of phonemes as classifiers, the results are shown in FIG. 15. Overall, it is observed that the system can achieve considerable accuracy by only using a few phonemes. Specifically, with just one phoneme being used, the system achieves over 89% accuracy, 94% recall, precision, and F1 score. Furthermore, the accuracy, recall, precision, and F1 score is improved to around 95%, 95%, 97%, and 98% respectively with only five phonemes. This result shows that EarDynamic can provide high authentication accuracy using only a few words for classifier boosting.

Moreover, the system performance is studied when utilizing dynamic deformation categorization based approach used in EarDynamic and static geometry based approach to generate templates for authentication. The static geometry-based approach generates the template when the user is under the static scenario (i.e, the user is not speaking). In this case, the generated template only represents the physiological characteristics of the ear canal. Using only static geometry of the ear canal provides a very good accuracy when the user is not speaking or moving the head. However, the ear canals of the user become dynamic when he/she is issuing voice commands or talking over the phone. Such dynamics cause ear canal deformation and degrade authentication performance Thus, the authentication system only utilizes the static information of the ear canal may not be sufficient under dynamic scenarios.

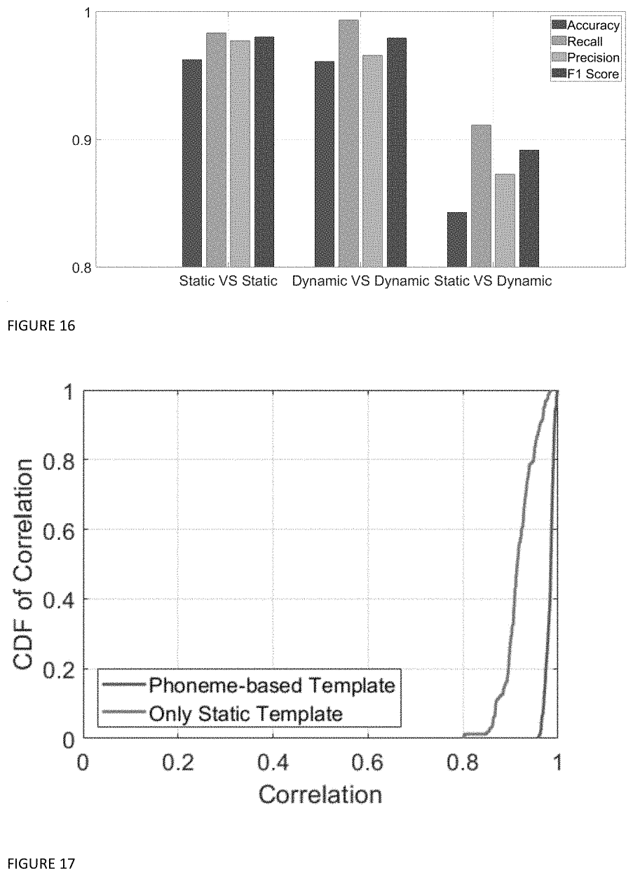

As shown in FIG. 16 under the first group of the bars “Static vs Static”, enrolling and authenticating the user with static features in a static scenario result in the best performance, which indicates that static templates work fine in static scenarios. However, it is unrealistic to assume that the user's ear canals are always in static status. Indeed, the user's ear canals are dynamic while the user is speaking and moving his/her head. In such cases, when the static features are used to authenticate dynamic ear canals, the authentication performance plummets as shown in the third group of “Static VS Dynamic”. To solve this problem, phoneme categories were introduced and dynamic templates were built based on them, then the dynamic ear canal template was used for the dynamic scenarios, and as the second group “Dynamic VS Dynamic” shows, authenticating with dynamic features achieve comparable results with first group. According to the results, it was observed that although static templates work fine under a static scenario, only relying on the static template is not sufficient. Therefore, it is believed that categorizing ear deformation by phonemes and building the dynamic ear canal profiles for the user could further enhance the performance and usability of the system.

Moreover, as shown in FIG. 17, during the authentication process, the correlation between extracted live user feature and dynamic deformation categorization based template is over 95% while the correlation between live user feature and the static geometry-based template is much lower. This shows our system can capture both the physiological and behavioral characteristics of the ear canal and defend against mimic attack.

Performance Under Advanced Attack

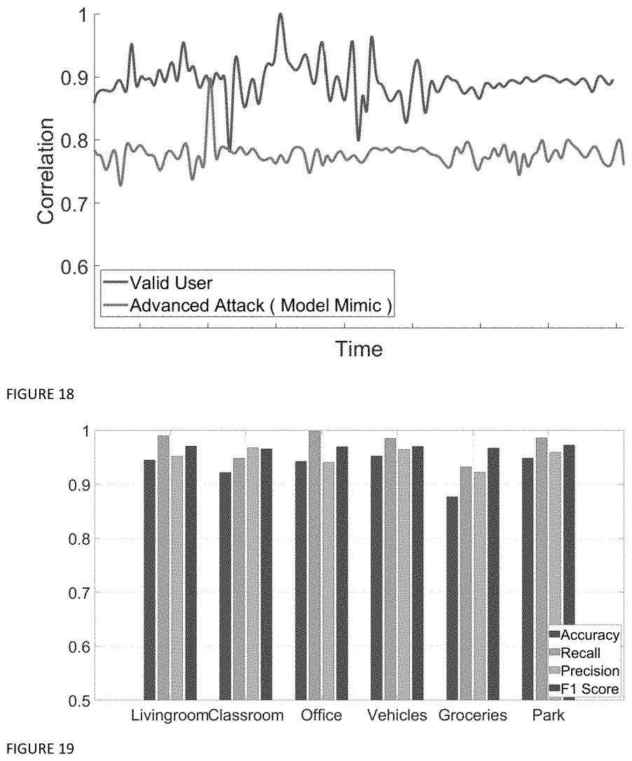

Next, the performance of the system was evaluated under the advanced attack. To launch such an attack, the adversary leverages the leaked ear canal static geometry information of the victim and rebuilds the ear canal model. For this type of attacks, the attacker can only replicate the static geometry of the victim's ear canal at best and miss the dynamic deformation motion information when the user is speaking. Thus, to simulate the advanced attack, the participants were asked to wear the in-ear devices and replay their voice commands from other devices. The users keep silent during the authentication process. As shown in FIG. 18, the blue curve is the correlation of the live user extracted feature with respect to the template and the red curve is the correlation of the advanced attack scenario extracted feature with respect to the template. It is observed that the correlation of the live user with respect to the template is consistently higher during the authentication process. This is because the advanced attack scenario can only capture the static geometry feature of the ear canal while missing the dynamic deformation motion information. Moreover, the false accept rate under the advanced attack is 5.3% and the false reject rate is 2.9%. This is because the dynamic deformation can only be captured through live user and can not be spoofed by the advanced attack. Such results show the system is effective in defending against advanced attacks.

Impact of Different Environments

As people may wear in-ear devices at various locations, here the system's performance is studied in different environments. Six typical environments were chosen: living room, classroom, office, vehicles, grocery store, and park. FIG. 19 shows that the system performance in the abovementioned environments. It was observed that the system still works well even across different environments. In particular, the accuracy of the system in six different environments are 94.50%, 92.17%, 94.25%, 95.25%, 87.70%, 94.83%, respectively. Moreover, it was observed that all the environments besides the grocery store achieve comparable performance. Although the accuracy is slightly lower in the grocery store due to substantial background noises within the environment, the system still provides high authentication accuracy. Such observations show that the system is robust and can work well in different environments.

Impact of Head Posture

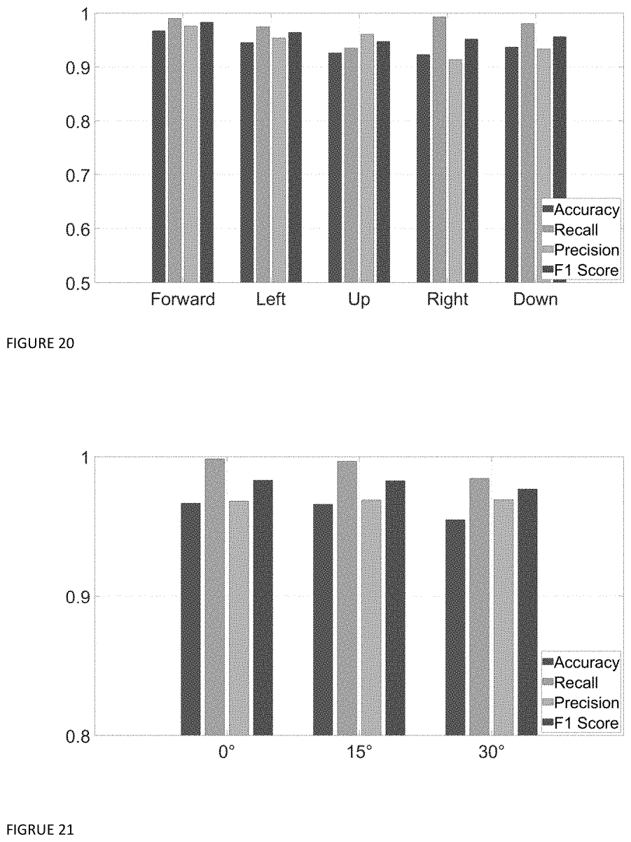

Difference head postures also impact the ear deformation, thus it is studied how these head postures impact the system. The head postures considered are facing left, up, right, and down and using facing forward as the baseline. A motion sensor is used that is attached to the earbud to detect the head postures and decided to match with which template. As shown in FIG. 20, comparing with facing forward, the accuracy drop 2% to 4% for other head postures. Although compare with facing forward, a slight drop in the accuracy could be seen, the system still has good authentication accuracy under different head posture. This observation demonstrates that the system can work well when the users are speaking with different head postures.

Impact of Wearing Positions

People usually wear earbuds in their habitual position, it is possible the relative position of the earbud with respect to the ear could be slightly different from time to time. Next, the wearing position of the in-ear devices' impact on the system performance was evaluated. Three different wearing angles with respect to the normal wear position were evaluated: 0°, 15°, and 30°. Additional 160 sentences for case of 15°, and 30° and 240 datapoints are used in total. The measured angle is facing toward the earlobe with respect to the original position and 0° is used to establish the baseline performance. The results are shown in FIG. 21. It was observed that the system achieves similar performance across different wearing angles. In particular, the accuracy for 15° and 30° wearing angles are over 95%. This demonstrates the system is not sensitive to different wearing positions.

Impact of Time

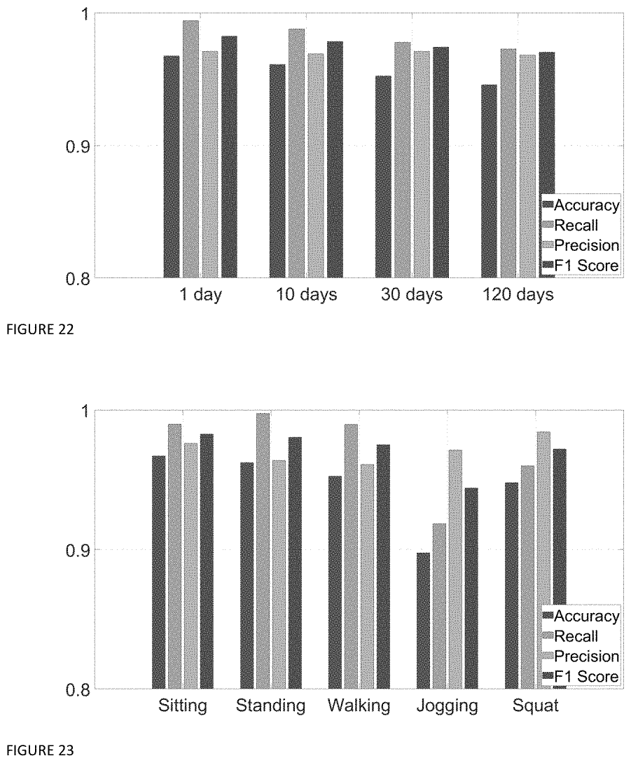

To evaluate the robustness of the system over time, some participants were asked to use the system over various time periods after initial enrollment. The time periods considered are 1 day, 10 days, 30 days, and 120 days. 140 additional sentences are sampled for 30 days and 120 days, 300 sentences are analyzed in total. As shown in FIG. 22, it was observed that the system can maintain high performance over various time periods. In particular, the system achieves accuracy over 95% after 120 days. This is due to the consistency of the ear canal dynamic deformation and static geometry for adults. However, it is worth noticing that the static geometry of the ear canal can change gradually when the user is aging. Thus it is important to update the template if the user plans to use the system for an extended period of time (e.g., over one year).

Impact of Body Motion

As it is known that different gestures could make an impact on the ear canal, here it is studied how different body motions affect the performance of our system. The motions chosen are daily activities including sitting, standing, walking, jogging, and squat. For walking, jogging, and squat, 360 sentences were collected in addition. As shown in FIG. 23, this system can maintain high accuracy when the users are performing different body motions. Although the performance of the system drops during jogging, it can still achieve around 90% accuracy. It is possible the heavy breathing during jogging can change the way users speak. Therefore, the dynamic deformation motion when pronouncing the same phoneme under the jogging scenario is different and leads to an accuracy drop. Nevertheless, the results, in general, show that the system is robust to various body motions.

Study of Left and Right Ear

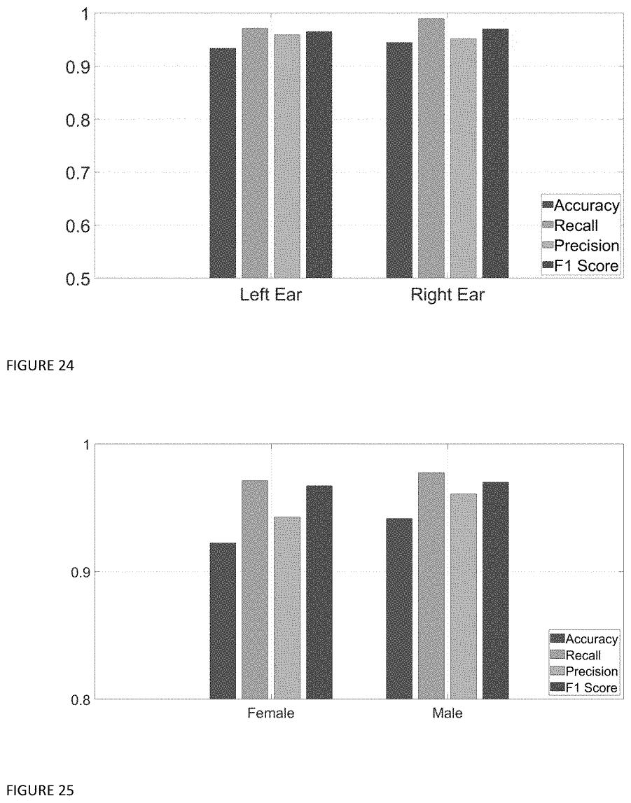

Next, the system performance was studied over different ears. The participants were asked to use either left or right ear to enroll in the system and then utilize the corresponding ear for authentication. The results are shown in FIG. 24. Overall, the system is effective in authenticating the user using either ear. In particular, the accuracy and precision using the left ear are 93.31% and 95.58%. For the right ear, the accuracy is 94.45% and precision is 95.17%. In this work, one ear (i.e., left ear) is primarily used for experimental evaluation if not specified. Furthermore, when the user is wearing both earbuds, it provides us the opportunity to further enhance the system security by using the other ear as a secondary authentication factor.

A user study based on the dataset on different factors including gender, accent, and age.

Gender. The impact of different gender was studied. 24 participants were recruited including 12 females and 12 males. As shown in FIG. 25, the average accuracy, recall, precision, and F1 score for female are 92.24% 97.12% 94.27%, and 96.72%, respectively. And for male, they are 94.16% 97.75% 96.07%, and 97.00%, respectively. These results suggest that, in general, the system yields better performance on male users. It was observed that this could be caused by the different anatomical composition and speaking habits, e.g., the male user usually has louder volume and bigger articulator gestures compared with the female users.

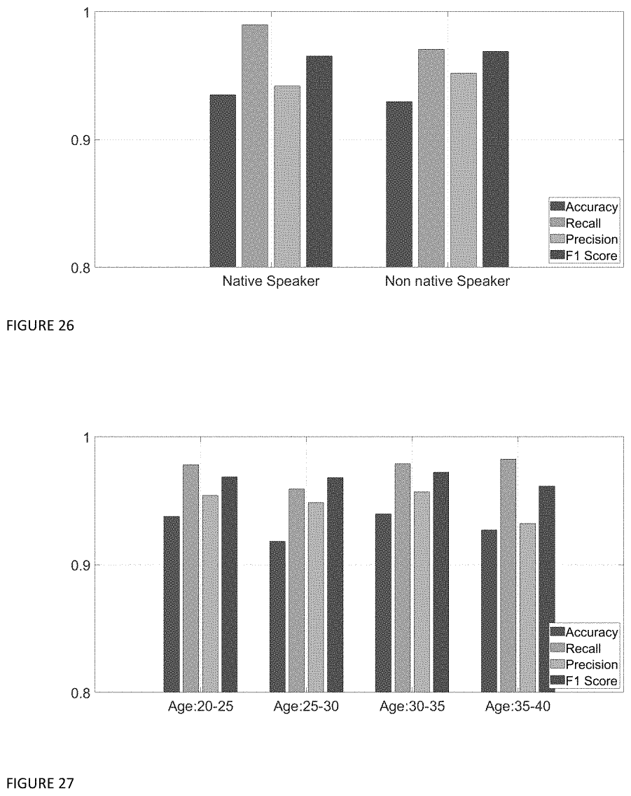

Accent. Both native English speakers and non-native English speakers are recruited for the accent experiments. In particular, there are 4 Native English speakers and 20 non-native English speakers from different countries. According to the FIG. 26, the average accuracy, recall, precision, and F1 score for native speakers are 93.48% 98.97% 94.18%, and 96.52%, whereas for non-native speakers, they are 92.95% 97.07% 95.19%, and 96.90%, respectively.

Indeed, comparing with native English speakers, non-native speakers' pronunciations are less stable. For example, non-native speakers are prone to mispronounce phonemes. Such inconsistency might impact the authentication and lower our system performance.

Age. Can age affect system performance? The participants are divided into four age categories: 20-25, 25-30, 30-35, and 35-40. FIG. 26 shows the average accuracy, recall, precision, and F1 score for these age groups. It was observed that the system provides stable appropriate performance for all the age groups from 20 to 40. Specifically, the authentication accuracies for all age groups are above 93% and the variances are less than 1%.

It will be apparent to those skilled in the art that various modifications and variations can be made in the present disclosure without departing from the scope or spirit of the invention. Other embodiments of the disclosure will be apparent to those skilled in the art from consideration of the specification and practice of the methods disclosed herein. It is intended that the specification and examples be considered as exemplary only, with a true scope and spirit of the invention being indicated by the following claims.

### REFERENCES

[1] 2017. HUAWEI FreeBuds 3. https://consumer.huawei.com/en/audio/freebuds3/[2]2020. Wireless Bluetooth Sports Headphones. https://www.jabra.com/sports-headphones
[3] Aditya Abhyankar and Stephanie Schuckers. 2009. Integrating a wavelet based perspiration liveness check with fingerprint recognition. Pattern Recognition 42, 3 (2009), 452-464.
[4] Amazon. 2020. Amazon Echo Buds. https://www.amazon.com/Echo-Buds/dp/B07F6VM1S3/[5]
[5] Takashi Amesaka, Hiroki Watanabe, and Masanori Sugimoto. 2019. Facial expression recognition using ear canal transfer function. In Proceedings of the 23rd International Symposium on Wearable Computers. 1-9.
[6] Apple. 2020. Apple AirPods Pro. https://www.apple.com/airpods-pro/[7] Takayuki Arakawa, Takafumi Koshinaka, Shohei Yano, Hideki Irisawa, Ryoji Miyahara, and Hitoshi Imaoka. 2016. Fast and accurate personal authentication using ear acoustics. In 2016 Asia-Pacific Signal and Information Processing Association Annual Summit and Conference (APSIPA). IEEE, 1-4.
[8] Hind Baqeel and Saqib Saeed. 2019. Face Detection Authentication on Smartphones: End Users Usability Assessment Experiences. In 2019 International Conference on Computer and Information Sciences (ICCIS). IEEE, 1-6.
[9] Abdelkareem Bedri, David Byrd, Peter Presti, Himanshu Sahni, Zehua Gue, and Thad Starner. 2015. Stick it in your ear: Building an in-ear jaw movement sensor. In Adjunct Proceedings of the 2015 ACM International Joint Conference on Pervasive and Ubiquitous Computing and Proceedings of the 2015 ACM International Symposium on Wearable Computers. 1333-1338.
[10] Johan Carioli, Aidin Delnavaz, Ricardo J Zednik, and Jérémie Voix. 2017. Piezoelectric earcanal bending sensor. IEEE Sensors Journal 18, 5 (2017), 2060-2067.
[11] Phillip L De Leon, Michael Pucher, Junichi Yamagishi, Inma Hernaez, and Ibon Saratxaga. 2012. Evaluation of speaker verification security and detection of HMM-based synthetic speech. IEEE Transactions on Audio, Speech, and Language Processing 20, 8 (2012), 2280-2290.
[12] Aidin Delnavaz and Jérémie Voix. 2013. Energy harvesting for in-ear devices using ear canal dynamic motion. IEEE Transactions on Industrial Electronics 61, 1 (2013), 583-590.
[13] Jianjiang Feng, Anil K Jain, and Arun Ross. 2009. Fingerprint alteration. submitted to IEEE TIFS (2009).
[14] Matteo Ferrara, Annalisa Franco, and Davide Maltoni. 2016. On the effects of image alterations on face recognition accuracy. In Face recognition across the imaging spectrum. Springer, 195-222.
[15] Yang Gao, Wei Wang, Vir V Phoha, Wei Sun, and Zhanpeng Jin. 2019. EarEcho: Using Ear Canal Echo for Wearable Authentication. Proceedings of the ACM on Interactive, Mobile, Wearable and Ubiquitous Technologies 3, 3 (2019), 1-24.
[16] Valentin Goverdovsky, David Looney, Preben Kidmose, and Danilo P Mandic. 2015. In-ear EEG from viscoelastic generic earpieces: Robust and unobtrusive 24/7 monitoring. IEEE Sensors Journal 16, 1 (2015), 271-277.
[17] Malcolm J Grenness, Jon Osborn, and W Lee Weller. 2002. Mapping ear canal movement using area-based surface matching. The Journal of the Acoustical Society of America 111, 2 (2002), 960-971.
[18] Rosa González Hautamäki, Tomi Kinnunen, Ville Hautamäki, Timo Leino, and Anne-Maria Laukkanen. 2013. I-vectors meet imitators: on vulnerability of speaker verification systems against voice mimicry . . . . In Interspeech. 930-934.
[19] Mandieh Izadpanahkakhk, Seyyed Mohammad Razavi, Mehran Taghipour-Gorjikolaie, Seyyed Hamid Zahiri, and Aurelio Uncini. 2018. Deep region of interest and feature extraction models for palmprint verification using convolutional neural networks transfer learning. Applied Sciences 8, 7 (2018), 1210.
[20] Amin Jalali, Rommohan Mallipeddi, and Minho Lee. 2015. Deformation invariant and contactless palmprint recognition using convolutional neural network. In Proceedings of the 3rd International Conference on Human-Agent Interaction. 209-212.
[21] Artur Janicki, Federico Alegre, and Nicholas Evans. 2016. An assessment of automatic speaker verification vulnerabilities to replay spoofing attacks. Security and Communication Networks 9, 15 (2016), 3030-3044.
[22] Tomi Kinnunen, Md Sahidullah, Héctor Delgado, Massimiliano Todisco, Nicholas Evans, Junichi Yamagishi, and Kong Aik Lee. 2017. The ASVspoof 2017 challenge: Assessing the limits of replay spoofing attack detection. (2017).
[23] Andreas Kipp, M-B Wesenick, and Florian Schiel. 1996. Automatic detection and segmentation of pronunciation variants in German speech corpora. In Proceeding of Fourth International Conference on Spoken Language Processing. ICSLP'96, Vol. 1. IEEE, 106-109. Proc. ACM Interact. Mob. Wearable Ubiquitous Technol., Vol. 5, No. 1, Article 39. Publication date: March 2021. EarDynamic: An Ear Canal Deformation Based Continuous User Authentication . . . 39:27
[24] Thomas Kisler, Florian Schiel, and Han Sloetjes. 2012. Signal processing via web services: the use case WebMAUS. In Digital Humanities Conference 2012.
[25] Rajamani Santhosh Kumar, K R Jothi Kumar, D Saravana Bhavan, and A Anandaraj. [n.d.]. Variations in the External Auditory Canal of 185 Adult Individuals: A Clinico-Morphological Study. International Journal of Scientific and Research Publications ([n. d.]), 305.
[26] Nianfeng Liu, Man Zhang, Haiqing Li, Zhenan Sun, and Tieniu Tan. 2016. DeepIris: Learning pairwise filter bank for heterogeneous iris verification. Pattern Recognition Letters 82 (2016), 154-161.
[27] Davide Maltoni, Dario Maio, Anil K Jain, and Salil Prabhakar. 2009. Handbook of fingerprint recognition. Springer Science & Business Media.
[28] Emanuela Marasco and Arun Ross. 2014. A survey on antispoofing schemes for fingerprint recognition systems. ACM Computing Surveys (CSUR) 47, 2 (2014), 1-36.
[29] Gian Luca Marcialis, Fabio Roli, and Alessandra Tidu. 2010. Analysis of fingerprint pores for vitality detection. In 2010 20th international conference on pattern recognition. IEEE, 1289-1292.
[30] Amir Mohammadi, Sushil Bhattacharjee, and Sébastien Marcel. 2017. Deeply vulnerable: a study of the robustness of face recognition to presentation attacks. IET Biometrics 7, 1 (2017), 15-26.
[31] Jang-Ho Park, Dae-Geun Jang, Jung Wook Park, and Se-Kyoung Youm. 2015. Wearable sensing of in-ear pressure for heart rate monitoring with a piezoelectric sensor. Sensors 15, 9 (2015), 23402-23417.
[32] Chester Pirzanski and Brenda Berge. 2005. Ear canal dynamics: Facts versus perception. The Hearing Journal 58, 10 (2005), 50-52.
[33] Kiran B Raja, Ramachandra Raghavendra, Vinay Krishna Vemuri, and Christoph Busch. 2015. Smartphone based visible iris recognition using deep sparse filtering. Pattern Recognition Letters 57 (2015), 33-42.
[34] Daniel M Rasetshwane and Stephen T Neely. 2011. Inverse solution of ear-canal area function from reflectance. The Journal of the Acoustical Society of America 130, 6 (2011), 3873-3881.
[35] Mosur K Ravishankar 1996. Efficient Algorithms for Speech Recognition. Technical Report. Carnegie-Mellon Univ Pittsburgh pa Dept of Computer Science.
[36] U Rosenhall. 1996. The Human Ear Canal. Theoretical Considerations and Clinical Applications including Cerumen Management by BB Ballachandra. JOURNAL OF AUDIOLOGICAL MEDICINE 5 (1996), 176-177.
[37] Robert E Schapire and Yoav Freund. 2013. Boosting: Foundations and algorithms Kybernetes (2013).
[38] Ulrich Scherhag, Christian Rathgeb, Johannes Merkle, Ralph Breithaupt, and Christoph Busch. 2019. Face recognition systems under morphing attacks: A survey. IEEE Access 7 (2019), 23012-23026.
[39] Florian Schiel, Christoph Draxler, and Jonathan Harrington. 2011. Phonemic segmentation and labelling using the MAUS technique. (2011).
[40] Stephanie A C Schuckers. 2002. Spoofing and anti-spoofing measures. Information Security technical report 7, 4 (2002), 56-62.
[41] Chao Shen, Yuanxun Li, Yufei Chen, Xiaohong Guan, and Roy A Maxion. 2017. Performance analysis of multi-motion sensor behavior for active smartphone authentication. IEEE Transactions on Information Forensics and Security 13, 1 (2017), 48-62.
[42] Kaavya Sriskandaraja, Vidhyasaharan Sethu, Eliathamby Ambikairajah, and Haizhou Li. 2016. Front-end for antispoofing countermeasures in speaker verification: Scattering spectral decomposition. IEEE Journal of Selected Topics in Signal Processing 11, 4 (2016), 632-643.
[43] Michael R Stinson and BW Lawton. 1989. Specification of the geometry of the human ear canal for the prediction of sound-pressure level distribution. The Journal of the Acoustical Society of America 85, 6 (1989), 2492-2503.
[44] Boudewijn Venema, Johannes Schiefer, Vladimir Blazek, Nikolai Blanik, and Steffen Leonhardt. 2013. Evaluating innovative in-ear pulse oximetry for unobtrusive cardiovascular and pulmonary monitoring during sleep. IEEE journal of translational engineering in health and medicine 1 (2013), 2700208-2700208.
[45] Rudolf M Verdaasdonk and Niels Liberton. 2019. The Iphone X as 3D scanner for quantitative photography of faces for diagnosis and treatment follow-up (Conference Presentation). In Optics and Biophotonics in Low-Resource Settings V, Vol. 10869. International Society for Optics and Photonics, 1086902.
[46] Jérémie Voix. 2017. The ear beyond hearing: From smart earplug to in-ear brain computer interfaces. In Proc. 24th Int. Congr. Sound Vibrat. (ICS V). 1-11.
[47] Chen Wang, Junping Zhang, Jian Pu, Xiaoru Yuan, and Liang Wang. 2010. Chrono-gait image: A novel temporal template for gait recognition. In European Conference on Computer Vision. Springer, 257-270.
[48] Mao-Che Wang, Chia-Yu Liu, An-Suey Shiao, and Tyrone Wang. 2005. Ear problems in swimmers. Journal of the chinese medical association 68, 8 (2005), 347-352.
[49] Zhizheng Wu, Tomi Kinnunen, Nicholas Evans, Junichi Yamagishi, Cemal Hanilçi, Md Sahidullah, and Aleksandr Sizov. 2015. ASVspoof 2015: the first automatic speaker verification spoofing and countermeasures challenge. In Sixteenth Annual Conference of the International Speech Communication Association.

What is claimed is:

1. A system for acoustic authentication of a user, the system comprising:
a microphone configured to face into the ear canal of a user, wherein said microphone comprises
a transmitter for transmitting a probe signal, and
a receiver for receiving and recording signal reflections from the ear canal of the user, wherein said signal reflections are based on ear canal dynamic deformation and ear canal geometry information;
an authenticator, configured to determine a current user acoustic signature from the receiver and to compare the current user acoustic signature with a predefined user acoustic signature and to authenticate the user based on the comparison of the current user acoustic signature with the predefined user acoustic signature; and
housing, wherein said microphone and authenticator are housed inside said housing.

2. The system of claim 1, wherein the system is an in-ear wearables.

3. The system of claim 2, wherein said earpiece is designed to fit into the ear of the user.

4. The system of claim 2, wherein the in-ear wearables include earbuds, earpieces and headsets.

5. The system of claim 4, wherein said headset is configured to both wirelessly and wiredly connect to a device.

6. The system of claim 5, wherein the device plays both inaudible and audible transmissions which are received by the headset.

7. The system of claim 1, wherein said recording can be accomplished on-demand or continually.

8. The system of claim 1, wherein the dynamic deformations are due to jaw motion, for instance, speaking, and head motion.

9. The system of claim 1, wherein the probe signal is a non-audible stimulus.

10. The system of claim 1, wherein a high pass filter is used in the receiver to separate inaudible and audible signals.

11. The system of claim 1, wherein the system further comprises a motion sensor.

12. The system of claim 11, wherein the motion sensor detects motion of the head.

13. A method of acoustic authentication of a user using at least one headset, which headset comprises:
a microphone configured to face into the ear canal of the user, wherein said microphone comprises
a transmitter for transmitting a probe signal, and
a receiver for receiving and recording signal reflections from the ear canal of the user, wherein said signal reflections are based on ear canal dynamic deformation and ear canal geometry information;
an authenticator, configured to determine a current user acoustic signature from the receiver and to compare the current user acoustic signature with a predefined user acoustic signature and to authenticate the user based on the comparison of the current user acoustic signature with the predefined user acoustic signature; and
housing, wherein said microphone and authenticator are housed inside said housing; wherein the headset authenticates the user based on ear canal dynamic deformation.

14. The method of claim 13, wherein the device plays both inaudible and audible transmissions which are received by the headset.

15. The method of claim 13, wherein said recording can be accomplished on-demand or continually.

16. The method of claim 13, wherein the dynamic deformations are due to jaw motion, for instance, speaking, and head motion.

17. The method of claim 13, wherein the probe signal is a non-audible stimulus.

18. The method of claim 13, wherein a high pass filter is used in the receiver to separate inaudible and audible signals.

19. The method of claim 13, wherein the system further comprises a motion sensor.

20. The method of claim 19, wherein the motion sensor detects motion of the head.
